(19) United States
(12) Patent Application Publication
(10) Pub. No.: US 2025/0373963 A1
(43) Pub. Date: Dec. 4, 2025

(54) EXTENDED DELIMITER FOR BURST MODE COMMUNICATIONS

(71) Applicant: Nokia Solutions and Networks Oy, Espoo (FI)

(72) Inventors: Amitkumar Mahadevan, Edison, NJ (US); Yannick Lefevre, Heverlee (BE); Werner Van Hoof, Aartselaar (BE)

(21) Appl. No.: 18/680,706

(22) Filed: May 31, 2024

(51) Int. Cl. H04Q 11/00

(52) U.S. Cl. CPC H04Q 11/0062; H04Q 2011/0079; H04Q 2011/0088

(57) ABSTRACT

Various example embodiments for supporting burst mode communications in an optical communication system may be configured to support burst mode communications based on use of an extended delimiter for improved burst detection. The extended delimiter for a burst may be constructed within an upstream physical synchronization block (PSBu) of the burst for enabling detection of the burst and recovery of the burst payload of the burst based on delineation of the burst payload using the extended delimiter. The extended delimiter may be constructed within a PSBu of a burst based on concatenation of multiple PSBu sub-segments of one or more PSBu segments of the PSBu. The extended delimiter may be used for burst detection within various types of optical communication networks, including passive optical networks (PONs).

### TECHNICAL FIELD

Various example embodiments relate generally to communication systems and, more particularly but not exclusively, to supporting optical communications in optical communication systems.

### BACKGROUND

Various communications technologies may be used to support communications in various types of communication systems.

### SUMMARY

In at least some example embodiments, an apparatus includes at least one processor and at least one memory storing instructions which, when executed by the at least one processor, cause the apparatus at least to determine information defining an extended delimiter for a physical synchronization block of a burst mode transmission, wherein the extended delimiter is based on concatenation of at least two physical synchronization block sub-segments of at least one physical synchronization block segment, wherein two or more of the at least two physical synchronization block sub-segments have non-zero length, and send, toward a transceiver, a set of management messages including the information defining the extended delimiter. In at least some example embodiments, the information defining the extended delimiter comprises, for each of the two or more of the at least two physical synchronization block sub-segments, a respective indication of a length of the physical synchronization block sub-segment and a respective indication of a bit pattern for the physical synchronization block sub-segment. In at least some example embodiments, the apparatus is configured to be disposed within a passive optical network, and the set of management messages comprises at least one physical layer operations administration and maintenance (PLOAM) message. In at least some example embodiments, the apparatus is configured to be disposed within a passive optical network, and the set of management message comprises, for each of the at least two physical synchronization block sub-segments, a respective PLOAM message for the respective physical synchronization block segment. In at least some example embodiments, the two or more of the at least two physical synchronization block sub-segments belong to a same one of the at least one physical synchronization block segment. In at least some example embodiments, the two or more of the at least two physical synchronization block sub-segments belong to different ones of the at least one physical synchronization block segment. In at least some example embodiments, the at least one physical synchronization block segment includes a first physical synchronization block segment and a second physical synchronization block segment, and the two or more of the at least two physical synchronization block sub-segments include a first physical synchronization block sub-segment belonging to the first physical synchronization block segment and a second physical synchronization block sub-segment belonging to the second physical synchronization block segment. In at least some example embodiments, the two or more of the at least two physical synchronization block sub-segments include at least two delimiter sub-segments. In at least some example embodiments, the two or more of the at least two physical synchronization block sub-segments include at least one preamble sub-segment and at least one delimiter sub-segment. In at least some example embodiments, the two or more of the at least two physical synchronization block sub-segments include at least two preamble sub-segments. In at least some example embodiments, for each of the two or more of the at least two physical synchronization block sub-segments, the respective physical synchronization block sub-segment is defined to include a respective bit pattern characteristic of a delimiter bit pattern and configured for use as a respective portion of the extended delimiter. In at least some example embodiments, the extended delimiter comprises a 96-bit delimiter based on concatenation of a 32-bit physical synchronization block sub-segment and a 64-bit physical synchronization block sub-segment. In at least some example embodiments, the extended delimiter comprises a 128-bit delimiter based on concatenation of a first 64-bit physical synchronization block sub-segment and a second 64-bit physical synchronization block sub-segment. In at least some example embodiments, the extended delimiter comprises an M×N bit delimiter, wherein M comprises a number of sub-segments in the two or more of the at least two sub-segments and N comprises a number of bits per sub-segment in the two or more of the at least two sub-segments. In at least some example embodiments, the instructions, when executed by the at least one processor, cause the apparatus at least to receive a bit stream of a burst mode transmission, wherein the burst mode transmission includes a burst payload and the extended delimiter, and recover, based on identification of the burst mode transmission using the extended delimiter, the burst payload. In at least some example embodiments, for each of the two or more of the at least two physical synchronization block sub-segments, the respective physical synchronization block sub-segment includes a respective bit pattern for use as a respective portion of the extended delimiter. In at least some example embodiments, the information defining the extended delimiter is configured for use by the transceiver when transmitting the burst mode transmission. In at least some example embodiments, the apparatus comprises an optical line terminal or an optical network unit.

In at least some example embodiments, a computer-readable storage medium stores computer program instructions which, when executed by an apparatus, cause the apparatus at least to determine information defining an extended delimiter for a physical synchronization block of a burst mode transmission, wherein the extended delimiter is based on concatenation of at least two physical synchronization block sub-segments of at least one physical synchronization block segment, wherein two or more of the at least two physical synchronization block sub-segments have non-zero length, and send, toward a transceiver, a set of management messages including the information defining the extended delimiter. In at least some example embodiments, the information defining the extended delimiter comprises, for each of the two or more of the at least two physical synchronization block sub-segments, a respective indication of a length of the physical synchronization block sub-segment and a respective indication of a bit pattern for the physical synchronization block sub-segment. In at least some example embodiments, the apparatus is configured to be disposed within a passive optical network, and the set of management messages comprises at least one physical layer operations administration and maintenance (PLOAM) message. In at least some example embodiments, the apparatus is configured to be disposed within a passive optical network, and the set of management message comprises, for each of the at least two physical synchronization block sub-segments, a respective PLOAM message for the respective physical synchronization block segment. In at least some example embodiments, the two or more of the at least two physical synchronization block sub-segments belong to a same one of the at least one physical synchronization block segment. In at least some example embodiments, the two or more of the at least two physical synchronization block sub-segments belong to different ones of the at least one physical synchronization block segment. In at least some example embodiments, the at least one physical synchronization block segment includes a first physical synchronization block segment and a second physical synchronization block segment, and the two or more of the at least two physical synchronization block sub-segments include a first physical synchronization block sub-segment belonging to the first physical synchronization block segment and a second physical synchronization block sub-segment belonging to the second physical synchronization block segment. In at least some example embodiments, the two or more of the at least two physical synchronization block sub-segments include at least two delimiter sub-segments. In at least some example embodiments, the two or more of the at least two physical synchronization block sub-segments include at least one preamble sub-segment and at least one delimiter sub-segment. In at least some example embodiments, the two or more of the at least two physical synchronization block sub-segments include at least two preamble sub-segments. In at least some example embodiments, for each of the two or more of the at least two physical synchronization block sub-segments, the respective physical synchronization block sub-segment is defined to include a respective bit pattern characteristic of a delimiter bit pattern and configured for use as a respective portion of the extended delimiter. In at least some example embodiments, the extended delimiter comprises a 96-bit delimiter based on concatenation of a 32-bit physical synchronization block sub-segment and a 64-bit physical synchronization block sub-segment. In at least some example embodiments, the extended delimiter comprises a 128-bit delimiter based on concatenation of a first 64-bit physical synchronization block sub-segment and a second 64-bit physical synchronization block sub-segment. In at least some example embodiments, the extended delimiter comprises an M×N bit delimiter, wherein M comprises a number of sub-segments in the two or more of the at least two sub-segments and N comprises a number of bits per sub-segment in the two or more of the at least two sub-segments. In at least some example embodiments, the computer program instructions, when executed by the apparatus, cause the apparatus at least to receive a bit stream of a burst mode transmission, wherein the burst mode transmission includes a burst payload and the extended delimiter, and recover, based on identification of the burst mode transmission using the extended delimiter, the burst payload. In at least some example embodiments, for each of the two or more of the at least two physical synchronization block sub-segments, the respective physical synchronization block sub-segment includes a respective bit pattern for use as a respective portion of the extended delimiter. In at least some example embodiments, the information defining the extended delimiter is configured for use by the transceiver when transmitting the burst mode transmission. In at least some example embodiments, the apparatus comprises an optical line terminal or an optical network unit.

In at least some example embodiments, a method includes determining information defining an extended delimiter for a physical synchronization block of a burst mode transmission, wherein the extended delimiter is based on concatenation of at least two physical synchronization block sub-segments of at least one physical synchronization block segment, wherein two or more of the at least two physical synchronization block sub-segments have non-zero length, and sending, toward a transceiver, a set of management messages including the information defining the extended delimiter. In at least some example embodiments, the information defining the extended delimiter comprises, for each of the two or more of the at least two physical synchronization block sub-segments, a respective indication of a length of the physical synchronization block sub-segment and a respective indication of a bit pattern for the physical synchronization block sub-segment. In at least some example embodiments, the method is configured to be executed by an apparatus disposed within a passive optical network, and the set of management messages comprises at least one physical layer operations administration and maintenance (PLOAM) message. In at least some example embodiments, the method is configured to be executed by an apparatus disposed within a passive optical network, and the set of management message comprises, for each of the at least two physical synchronization block sub-segments, a respective PLOAM message for the respective physical synchronization block segment. In at least some example embodiments, the two or more of the at least two physical synchronization block sub-segments belong to a same one of the at least one physical synchronization block segment. In at least some example embodiments, the two or more of the at least two physical synchronization block sub-segments belong to different ones of the at least one physical synchronization block segment. In at least some example embodiments, the at least one physical synchronization block segment includes a first physical synchronization block segment and a second physical synchronization block segment, and the two or more of the at least two physical synchronization block sub-segments include a first physical synchronization block sub-segment belonging to the first physical synchronization block segment and a second physical synchronization block sub-segment belonging to the second physical synchronization block segment. In at least some example embodiments, the two or more of the at least two physical synchronization block sub-segments include at least two delimiter sub-segments. In at least some example embodiments, the two or more of the at least two physical synchronization block sub-segments include at least one preamble sub-segment and at least one delimiter sub-segment. In at least some example embodiments, the two or more of the at least two physical synchronization block sub-segments include at least two preamble sub-segments. In at least some example embodiments, for each of the two or more of the at least two physical synchronization block sub-segments, the respective physical synchronization block sub-segment is defined to include a respective bit pattern characteristic of a delimiter bit pattern and configured for use as a respective portion of the extended delimiter. In at least some example embodiments, the extended delimiter comprises a 96-bit delimiter based on concatenation of a 32-bit physical synchronization block sub-segment and a 64-bit physical synchronization block sub-segment. In at least some example embodiments, the extended delimiter comprises a 128-bit delimiter based on concatenation of a first 64-bit physical synchronization block sub-segment and a second 64-bit physical synchronization block sub-segment. In at least some example embodiments, the extended delimiter comprises an M×N bit delimiter, wherein M comprises a number of sub-segments in the two or more of the at least two sub-segments and N comprises a number of bits per sub-segment in the two or more of the at least two sub-segments. In at least some example embodiments, the method includes receiving a bit stream of a burst mode transmission, wherein the burst mode transmission includes a burst payload and the extended delimiter, and recovering, based on identification of the burst mode transmission using the extended delimiter, the burst payload. In at least some example embodiments, for each of the two or more of the at least two physical synchronization block sub-segments, the respective physical synchronization block sub-segment includes a respective bit pattern for use as a respective portion of the extended delimiter. In at least some example embodiments, the information defining the extended delimiter is configured for use by the transceiver when transmitting the burst mode transmission. In at least some example embodiments, the method is configured to be executed by an optical line terminal or an optical network unit.

In at least some example embodiments, an apparatus includes means for determining information defining an extended delimiter for a physical synchronization block of a burst mode transmission, wherein the extended delimiter is based on concatenation of at least two physical synchronization block sub-segments of at least one physical synchronization block segment, wherein two or more of the at least two physical synchronization block sub-segments have non-zero length, and means for sending, toward a transceiver, a set of management messages including the information defining the extended delimiter. In at least some example embodiments, the information defining the extended delimiter comprises, for each of the two or more of the at least two physical synchronization block sub-segments, a respective indication of a length of the physical synchronization block sub-segment and a respective indication of a bit pattern for the physical synchronization block sub-segment. In at least some example embodiments, the apparatus is configured to be disposed within a passive optical network, and the set of management messages comprises at least one physical layer operations administration and maintenance (PLOAM) message. In at least some example embodiments, the apparatus is configured to be disposed within a passive optical network, and the set of management message comprises, for each of the at least two physical synchronization block sub-segments, a respective PLOAM message for the respective physical synchronization block segment. In at least some example embodiments, the two or more of the at least two physical synchronization block sub-segments belong to a same one of the at least one physical synchronization block segment. In at least some example embodiments, the two or more of the at least two physical synchronization block sub-segments belong to different ones of the at least one physical synchronization block segment. In at least some example embodiments, the at least one physical synchronization block segment includes a first physical synchronization block segment and a second physical synchronization block segment, and the two or more of the at least two physical synchronization block sub-segments include a first physical synchronization block sub-segment belonging to the first physical synchronization block segment and a second physical synchronization block sub-segment belonging to the second physical synchronization block segment. In at least some example embodiments, the two or more of the at least two physical synchronization block sub-segments include at least two delimiter sub-segments. In at least some example embodiments, the two or more of the at least two physical synchronization block sub-segments include at least one preamble sub-segment and at least one delimiter sub-segment. In at least some example embodiments, the two or more of the at least two physical synchronization block sub-segments include at least two preamble sub-segments. In at least some example embodiments, for each of the two or more of the at least two physical synchronization block sub-segments, the respective physical synchronization block sub-segment is defined to include a respective bit pattern characteristic of a delimiter bit pattern and configured for use as a respective portion of the extended delimiter. In at least some example embodiments, the extended delimiter comprises a 96-bit delimiter based on concatenation of a 32-bit physical synchronization block sub-segment and a 64-bit physical synchronization block sub-segment. In at least some example embodiments, the extended delimiter comprises a 128-bit delimiter based on concatenation of a first 64-bit physical synchronization block sub-segment and a second 64-bit physical synchronization block sub-segment. In at least some example embodiments, the extended delimiter comprises an M×N bit delimiter, wherein M comprises a number of sub-segments in the two or more of the at least two sub-segments and N comprises a number of bits per sub-segment in the two or more of the at least two sub-segments. In at least some example embodiments, the apparatus includes means for receiving a bit stream of a burst mode transmission, wherein the burst mode transmission includes a burst payload and the extended delimiter, and means for recovering, based on identification of the burst mode transmission using the extended delimiter, the burst payload. In at least some example embodiments, for each of the two or more of the at least two physical synchronization block sub-segments, the respective physical synchronization block sub-segment includes a respective bit pattern for use as a respective portion of the extended delimiter. In at least some example embodiments, the information defining the extended delimiter is configured for use by the transceiver when transmitting the burst mode transmission. In at least some example embodiments, the method is configured to be executed by an optical line terminal or an optical network unit.

In at least some example embodiments, an apparatus includes at least one processor and at least one memory storing instructions which, when executed by the at least one processor, cause the apparatus at least to receive at least one management message including information defining an extended delimiter for a physical synchronization block of a burst mode transmission, wherein the extended delimiter is based on concatenation of at least two physical synchronization block sub-segments of at least one physical synchronization block segment, wherein two or more of the at least two physical synchronization block sub-segments have non-zero length, and control, based on the information defining the extended delimiter, transmission of a burst mode transmission including the extended delimiter. In at least some example embodiments, a computer-readable storage medium stores computer program instructions which, when executed by an apparatus, cause the apparatus at least to receive at least one management message including information defining an extended delimiter for a physical synchronization block of a burst mode transmission, wherein the extended delimiter is based on concatenation of at least two physical synchronization block sub-segments of at least one physical synchronization block segment, wherein two or more of the at least two physical synchronization block sub-segments have non-zero length, and control, based on the information defining the extended delimiter, transmission of a burst mode transmission including the extended delimiter. In at least some example embodiments, a method includes receiving at least one management message including information defining an extended delimiter for a physical synchronization block of a burst mode transmission, wherein the extended delimiter is based on concatenation of at least two physical synchronization block sub-segments of at least one physical synchronization block segment, wherein two or more of the at least two physical synchronization block sub-segments have non-zero length, and controlling, based on the information defining the extended delimiter, transmission of a burst mode transmission including the extended delimiter. In at least some example embodiments, an apparatus includes means for receiving at least one management message including information defining an extended delimiter for a physical synchronization block of a burst mode transmission, wherein the extended delimiter is based on concatenation of at least two physical synchronization block sub-segments of at least one physical synchronization block segment, wherein two or more of the at least two physical synchronization block sub-segments have non-zero length, and means for controlling, based on the information defining the extended delimiter, transmission of a burst mode transmission including the extended delimiter.

### BRIEF DESCRIPTION OF THE DRAWINGS

The teachings herein can be readily understood by considering the following detailed description in conjunction with the accompanying drawings, in which:

FIG. 1 depicts an example embodiment of a passive optical network (PON) including an optical line terminal (OLT) and a set of optical network units (ONUs) configured to support burst mode communications based on an extended delimiter for burst detection;

FIG. 2 depicts an example of an upstream burst structure for upstream burst mode communications from an ONU to an OLT;

FIG. 3 depicts an example of anomalous events associated with detection of delimiters in upstream burst mode communications from an ONU to an OLT;

FIG. 4 depicts an example of an upstream burst structure for upstream burst mode communications from an ONU to an OLT where the upstream physical synchronization block (PSBu) has been enhanced to support use of multiple PSBu segments;

FIG. 5 depicts an example of a baseline burst detection scheme for a 64-bit delimiter;

FIG. 6 depicts examples of Hamming distance of a delimiter shifted to preceding bit sequences for certain preamble and delimiter combinations;

FIG. 7 depicts example embodiments for construction of an extended delimiter based on multiple PSBu segments of a PSBu;

FIG. 8 depicts an example embodiment of an enhanced burst detection scheme for a 128-bit extended delimiter;

FIG. 9 depicts an example embodiment of a method for use by an optical communication system to support burst mode communications based on an extended delimiter;

FIG. 10 depicts an example embodiment of a method for use by a burst mode receiver for supporting burst mode communications based on an extended delimiter;

FIG. 11 depicts an example embodiment of a method for use by a burst mode transmitter for supporting burst mode communications based on an extended delimiter; and

FIG. 12 depicts an example embodiment of a computer suitable for use in performing various functions presented herein.

To facilitate understanding, identical reference numerals have been used herein, wherever possible, in order to designate identical elements that are common among the various figures.

### DETAILED DESCRIPTION

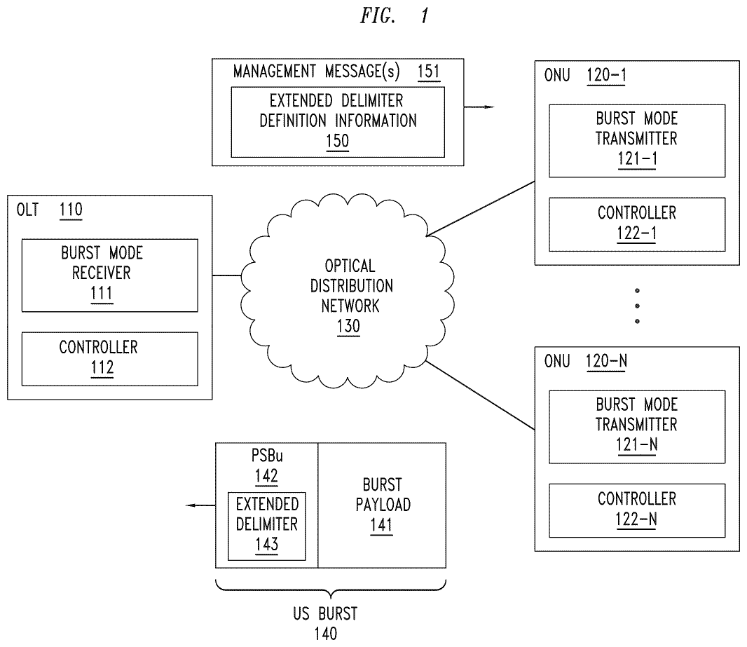

Various example embodiments for supporting burst mode communications in an optical communication system may be configured to support burst mode communications based on use of an extended delimiter for improved burst detection. The use of an extended delimiter within a burst including a burst payload enables detection of the start of the burst and recover of the burst payload of the burst based on delineation of the burst payload using the extended delimiter, which may be referred to herein as burst detection. The extended delimiter for a burst may be constructed within an upstream physical synchronization block (PSBu) of the burst for enabling detection of the burst and recovery of the burst payload of the burst based on delineation of the burst payload using the extended delimiter. The extended delimiter may be constructed within a PSBu of a burst based on concatenation of multiple PSBu sub-segments of one or more PSBu segments of the PSBu. The extended delimiter may be used for burst detection within various types of optical communication networks, including passive optical networks (PONs). It will be appreciated that the extended delimiter may be constructed in various other ways for supporting burst mode communications in various types of optical communication systems. It will be appreciated that these and various other example embodiments of supporting burst mode communications based on an extended delimiter may be further understood by way of reference to FIG. 1, which illustrates an example embodiment of a passive optical network configured to support burst mode communications.

FIG. 1 depicts an example embodiment of a passive optical network (PON) including an optical line terminal (OLT) and a set of optical network units (ONUs) configured to support burst mode communications based on use of an extended delimiter for burst detection.

The PON 100 may be configured to provide network access to a set of customers, based on optical communications, in various contexts and based on various technologies. For example, the PON 100 may operate as a point-to-multipoint (P2MP) data distribution system configured to provide broadband network access for customers (e.g., of a telecommunications network that supports communications for customers, including delivering communications to the customers and supporting communications from the customers). For example, the PON 100 may operate using various types of PON technologies and various PON standards (e.g., the G.9804 standard for 50G PON). It will be appreciated that the PON 100 may be used in various other contexts, configured based on various other PON technologies and/or PON standards, or the like, as well as various combinations thereof.

The PON 100 may include various communication elements configured to support optical communications. The PON 100 includes an optical line terminal (OLT) 110 and a set of optical network units (ONUs) 120-1-120-N (collectively, ONUs 120) connected via an optical distribution network (ODN) 130. The PON 100 may be configured to support downstream (DS) communications from the OLT 110 to the ONUs 120 via the ODN 130 and upstream (US) communications from the ONUs 120 to the OLT 110 via the ODN 130. The PON 100, as discussed further below, may be configured to US communications from the ONUs 120 to the OLT 110 based on burst mode communications supported using extended delimiters configured to provide improved burst detection for burst mode communications. It will be appreciated that the PON 100 may include various other elements (which have been omitted for purposes of clarity).

The OLT 110 is configured to support communications between the ONUs 120 and one or more upstream networks (omitted for purposes of clarity). The OLT 110 may be located in a central location, such as a central office (CO) or other suitable location. For example, the one or more upstream networks may include one or more core communication networks configured to support communications of the OLT 110 and, thus, of the ONUs 120. For example, the one or more upstream networks may include the Internet, data center networks, enterprise networks, or the like, as well as various combinations thereof. For example, the OLT 110 may be configured to forward data received from the one or more upstream networks downstream toward the ONUs 120 via the ODN 130 and to forward data received from the ONUs 120 via the ODN 130 upstream toward the one or more upstream networks. The OLT 110, as discussed further below, may be configured to support US communications from the ONUs 120 based on burst mode communications supported using extended delimiters configured to provide improved detection of the bursts for burst mode communications. For example, the OLT 110 includes a burst mode receiver 111 configured to support burst mode communications based on extended delimiters and a controller 112 configured to control operation of the burst mode receiver 111 to support burst mode communications based on extended delimiters. It will be appreciated that the OLT 110 may include various other elements (e.g., a transmitter or the like) configured to support optical communications within the PON 100.

The ONUs 120 each are configured to support communications between the OLT 110 and one or more downstream networks or devices (omitted for purposes of clarity). The ONUs 120 may be located at respective user premises or other suitable locations. For example, the one or more downstream networks or devices for an ONU 120 may include one or more local area networks (LANs) of the customer, one or more communication devices of the customer (e.g., a modem, a router, a switch, a set top box, a smart television, a gaming system, a computer, a smartphone, or the like, as well as various combinations thereof). For example, an ONU 120 may be configured to forward data received from the OLT 110 via the ODN 130 downstream toward one or more downstream networks or devices and to forward data received from the one or more downstream networks or devices upstream toward the OLT 110 via the ODN 130. The ONUs 120, as discussed further below, may be configured to support US communications to the OLT 110 based on burst mode communications supported using extended delimiters configured to provide improved burst detection for burst mode communications. The ONUs 120-1-120-N include burst mode transmitters 121-1-121-N (collectively, burst mode transmitters 121) configured to support burst mode communications based on extended delimiters and controllers 122-1-122-N (collectively, controllers 122) configured to control operation of the burst mode transmitters 121 to support burst mode communications based on extended delimiters, respectively. It will be appreciated that the ONUs 120 may include various other elements (e.g., receivers or the like) configured to support optical communications within the PON 100.

The ODN 130 may be a data distribution system configured to support communications between the OLT 110 and the ONUs 120, including DS communications from the OLT 110 to the ONUs 120 and US communications from the ONUs 120 to the OLT 110. The ODN 130, for purposes of clarity, is simply depicted as an optical fiber or set of optical fibers configured to support propagation of optical signals downstream from the OLT 110 to the ONUs 120 and upstream from the ONUs 120 to the OLT 110; however, it will be appreciated that the ODN 130 may be implemented using various different components which may be arranged in various different configurations. For example, the ODN 130 may include various passive optical components (e.g., optical fibers, optical couplers, optical splitters, and the like) which do not require power to distribute data signals between the OLT 110 and the ONUs 120. For example, the ODN 130 may be implemented using a branching configuration or other suitable P2MP configurations. It will be appreciated that the ODN 130 may include various other elements for supporting communications between the OLT 110 and the ONUs 120.

The PON 100, as indicated above, is configured to support US communications from the ONUs 120 to the OLT 110 using burst mode communications based on use of extended delimiters configured to provide improved burst detection for the burst mode communications. More specifically, in order to support an US burst from an ONU 120-x to the OLT 110 based on an extended delimiter, the OLT 110 and the ONU 120-x cooperate as follows. The ONU 120-x transmits an US burst 140 to the OLT 110. The US burst 140 includes a burst payload 141 and an upstream physical synchronization block (PSBu) 142. The PSBu 142 includes an extended delimiter 143 configured to support detection of the US burst 140 and delineation of the burst payload 141 within the US burst 140. The ONU 120-x generates the extended delimiter 143 based on extended delimiter definition information 150 which defines the extended delimiter 143, which is received by the ONU 120-x from the OLT 110. The extended delimiter definition information 150 which defines the extended delimiter 143 may be provided from the OLT 110 to the ONU 120-x using one or more management messages 151. The OLT 110 receives the US burst 140 from the ONU 120-x and recovers the burst payload 141 from the US burst 140 based on detection of the extended delimiter 143 included within the PSBu 142 based on the extended delimiter definition information 150. In this manner, the OLT 110 enables the ONU 120-x to generate extended delimiters for US bursts in a manner that improves detection of those US bursts when received at the OLT 110.

The extended delimiter 143 may be defined in various ways based on the particular context in which the extended delimiter 143 is being used. The extended delimiter 143, when used for burst detection in a particular context, may be a delimiter that is longer than the maximum length delimiter currently used for burst detection in that particular context. For example, within the context of a particular PON standard, the extended delimiter may be a delimiter that is longer than the delimiter currently defined for that particular PON standard (e.g., a delimiter longer than the 64-bit delimiter which is the maximum length delimiter currently used for the G.9804 standard for 50G PON) while still also enabling operation of the PON in accordance with the particular PON standard. This provides improved burst detection within the context of existing PON standards without the need for modification to the existing PON standards, thereby enabling support for improved burst detection within the context of existing PONs operating in accordance with existing PON standards. It will be appreciated that the definition of a delimiter as being “extended” so as to provide an extended delimiter for improved burst detection may be provided in various other ways which may depend on context in which improved burst detection is provided.

The extended delimiter 143 may be defined in various ways based on a PSBu. The extended delimiter 143 may be defined within a PSBu. The extended delimiter 143 may be defined using one or more PSBu segments of the PSBu. The extended delimiter 143 may be defined as a concatenation of a set of PSBu sub-segments of one or more PSBu segments of a PSBu, where the set of PSBu sub-segments may include at least two PSBu sub-segments of the one or more PSBu segments. The two or more PSBu sub-segments of the one or more PSBu segments of the PSBu for the extended delimiter 143 may include at least one delimiter sub-segment and at least one preamble sub-segment (of the same or different PSBu segments), at least two delimiter sub-segments (of different PSBu segments), or at least two preamble sub-segments (of different PSBu segments). For example, the extended delimiter 143 may be a 128-bit extended delimiter, which may be defined based on a concatenation of a 64-bit bit sequence disposed in a delimiter sub-segment of a first PSBu segment of the PSBu and a 64-bit bit sequence disposed in a preamble sub-segment of a second PSBu segment of the PSBu, a concatenation of a 64-bit bit sequence disposed in a first delimiter sub-segment of a first PSBu segment of the PSBu and a 64-bit bit sequence disposed in a second delimiter sub-segment of a second PSBu segment of the PSBu, or the like. It will be appreciated that the extended delimiter 143 may be defined to be shorter or longer than the 128 bit examples provided above. In this manner, various extended delimiters may be defined in various ways to support improved burst payload delineation for improved burst detection.

The extended delimiter definition information 150 for the extended delimiter 143 includes information defining the extended delimiter 143. The extended delimiter definition information 150 includes information configured to enable the ONU 120-x to generate the extended delimiter 143. The extended delimiter definition information 150 may include an indication of a length of the extended delimiter, one or more bit patterns for use as the extended delimiter, or the like, as well as various combinations thereof. The extended delimiter definition information 150 may include, for each PSBu sub-segment to be concatenated to form the extended delimiter 143, an indication of the length of the PSBu sub-segment, an indication of the bit pattern for the PSBu sub-segment, or the like, as well as various combinations thereof. The one or more management messages used to provide the extended delimiter definition information 150 from the OLT 110 to the ONU 120-x may include one or more physical layer operations administration and maintenance (PLOAM) messages. The one or more PLOAM messages may include a separate PLOAM message for each PSBu segment being defined to include at least a portion of the extended delimiter 143, with each PLOAM message for each PSBu segment including definition information for the PSBu sub-segments of the PSBu segment, respectively. It will be appreciated that the extended delimiter definition information 150 for the extended delimiter 143 may be defined in various other ways, may be communicated to the ONU 120-x in various other ways, or the like, as well as various combinations thereof.

It will be appreciated that various example embodiments for supporting extended delimiters for burst mode communications within the PON 100 may be further understood by first considering various aspects of optical communications, including PONs, more generally.

PONs, as indicated above, provide broadband access using a P2MP topology in which one OLT at the network side is used to connect to a multitude (e.g., up to 64) of ONUs at the user side by means of an ODN or fiber plant that contains optical fibers and splitters without active components. Most PON technologies, such as G-PON, E-PON, and XGS-PON, are time-division multiplexing (TDM) PON technologies, in which the fiber medium is shared in time between the different ONUs. In the DS direction (i.e., OLT to ONUs), the signal is broadcast from the OLT to all ONUs. In the US direction (i.e., ONUs to OLT), a time-division multiple-access (TDMA) scheme, also known as burst-mode (BM) operation, is employed in which the ONUs send burst signals that do not overlap in time. Also, time-and-wavelength-division multiplexing (TWDM) PON technologies exist, such as NG-PON2, in which multiple TDM systems at different wavelength are stacked to provide a wavelength dimension. Additionally, various standards have been defined for PON communications. For example, the ITU-T standardization body published the G.9804.3 standard for 50G PON (which combines a 50G line rate in DS with 12.5G and 25G in US), and then later published Amendment 1 of the G.9804.3 standard (which also includes a 50G US line rate). The G.9804.3 physical media dependent specification goes hand-in-hand with the G.9804.2 common transmission convergence layer specification, which specifies aspects related to framing of the data transmission.

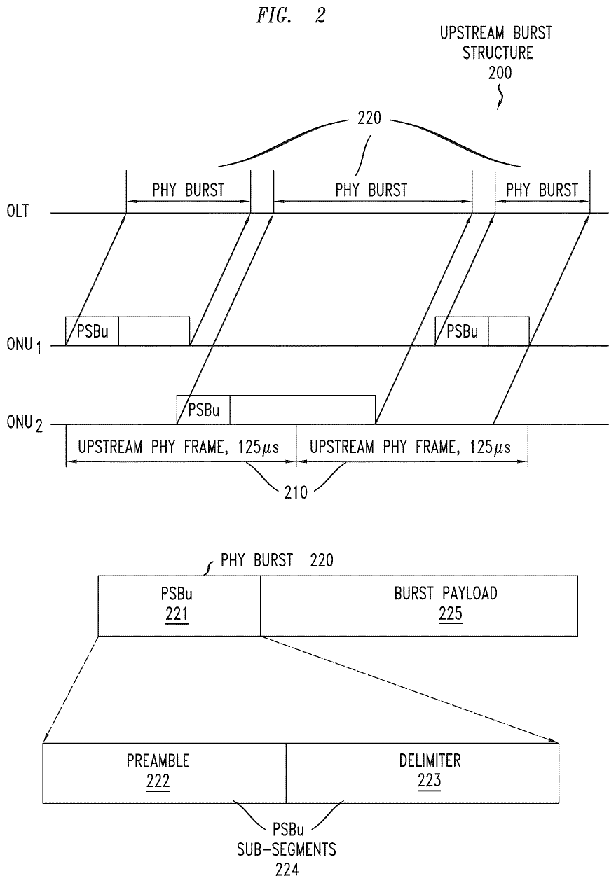

In a PON, in the US direction, BM communication is employed by the ONUs to transmit to the OLT using US bursts. The US burst transmitted from an ONU to the OLT typically includes an upstream physical synchronization block (PSBu) followed by the burst payload. In PON standards, such as XGS PON (G.9807.1), the PSBu consists of a preamble section followed by a delimiter (typically of length up to 64 bits). This is illustrated in FIG. 2, which depicts an example of an upstream burst structure for upstream burst mode communications from ONUs to an OLT. As illustrated in FIG. 2, an upstream burst structure 200 for XGS-PON includes TDM-based multiplexing of the upstream channel into 125 μs US physical frames 210 (two of which are illustrated, for purposes of clarity). As further illustrated in FIG. 2 and mentioned above, the ONUs transmit to the OLT using US physical bursts 220 (denoted as PHY bursts 220), where each US PHY burst 220 is composed of a PSBu 221 followed by an associated burst payload 225. In the example of FIG. 2, a first ONU (denoted as ONU1) sends an US PHY burst 220 to the OLT, then a second ONU (denoted as ONU2) sends an US PHY burst 220 to the OLT, and then the first ONU sends another US PHY burst 220 to the OLT. As further illustrated in FIG. 2 and also mentioned above, each PSBu 221 of an US PHY burst 220 is composed of a preamble 222 and a delimiter 223. The preamble 222 and the delimiter 223 are referred to herein as PSBu sub-segments 224 of the PSBu 221. The PSBu 221 of an US PHY burst 220 from an ONU to the OLT is configured to enable the OLT to detect the US PHY burst 220 from the ONU and recover the burst payload 225 of the US PHY burst 220.

In a PON, as indicated above, BM communication is employed by the ONUs to transmit to the OLT using US bursts. For normal US operation, the OLT sends control information in the DS direction to the ONUs for instructing the ONUs regarding various parameters for the US bursts sent by the ONUs to the OLT. For example, the OLT provides the ONUs with a bandwidth map (BWmap) which includes information on the ‘starttime’ and the ‘grantsize’ of the US bursts for the different ONUs. Nevertheless, the exact time instance of arrival of the US burst to the OLT is not known to the OLT due to clock wander and alignment uncertainty. As such, the successful detection and framing of an US burst at the OLT receiver is typically based on accurately identifying and delineating the delimiter, and, optionally, the preamble, in the PSBu of the US burst. The delimiter is typically a specially-designed pattern with features such as DC balance, large distance from all shifted patterns of itself, and large distance from all shifted patterns of the preceding preamble. A typical delimiter detection scheme involves examining bits in the incoming bit stream to match the delimiter while tolerating a certain number of bit errors (E). At the OLT, the delimiter search is deemed to be successful at the first occurrence of an acceptable match within the search window; however, two possible anomalous events may occur within the search window at the OLT: namely, a missing burst or a severely errored burst. These anomalous events are discussed further below.

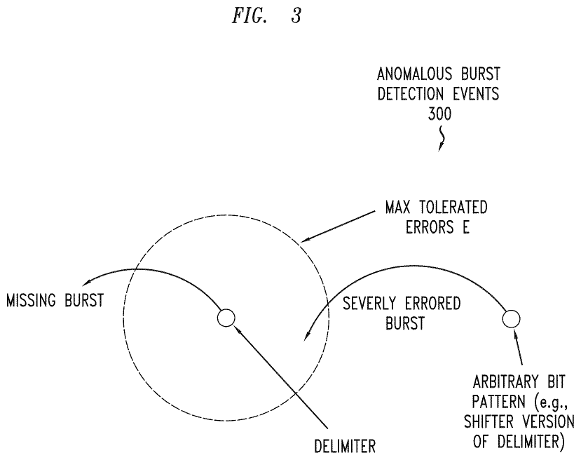

In US communication from an ONU to the OLT, BM communication based on US bursts may fail due to an unsuccessful search for the delimiter of the US burst which, as indicated above, may be due to a missing burst or a severely errored burst. A missing burst is deemed to have occurred where the ONU transmitted a burst, but the delimiter is not detected at the OLT within the search window due to more than the tolerable number of errors introduced by the channel. This is undesirable since it represents lost information. The associated probability is called the probability of missing burst (PMB). On the other hand, a severely errored burst is deemed to have occurred when a delimiter is detected at a location different from a true delimiter (e.g., shifted version of delimiter) due to errors introduced by the channel causing the received pattern to fall within the tolerable number of errors of the delimiter. This is undesirable since an inaccurate burst delineation and payload is sent to the upper layers of the OLT processing. The associated probability is called the probability of severely errored burst (PSEB). These anomalous events are illustrated in FIG. 3 as anomalous burst detection events 300. It will be appreciated that robust and efficient US BM communication relies on minimizing both PMB and PSEB for the worst-case US channel.

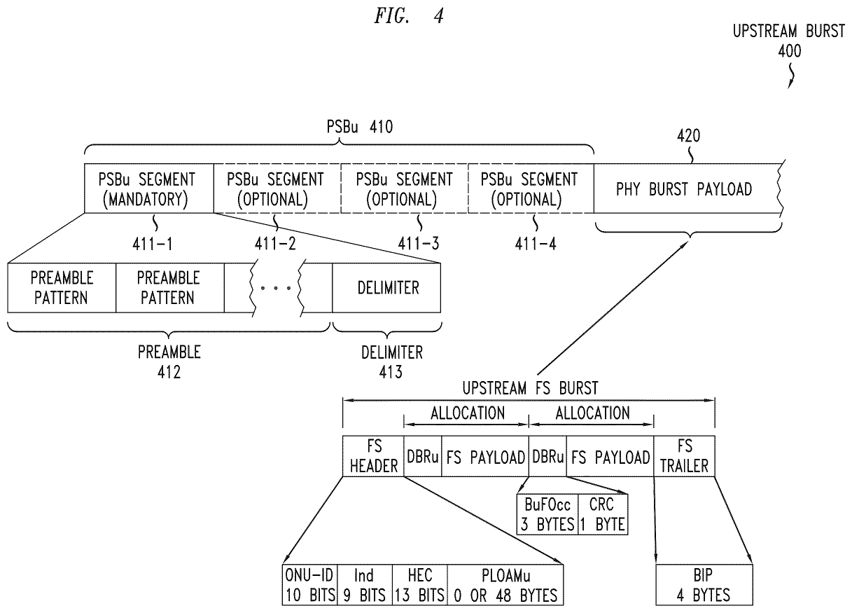

In the more recent 50G PON standard and associated common transmission conversion layer specification, for an US burst including a PSBu and a burst payload, the PSBu structure has been enhanced to include from one to four PSBu segments. This structure is depicted in FIG. 4. As illustrated in FIG. 4, an upstream burst 400 includes a PSBu 410 and a PHY burst payload 420. The PSBu 410 is composed of at least one PSBu segment 411 and possibly up to four PSBu segments 411 (which are illustrated as PSBu segments 411-1 to 411-4). As illustrated, each PSBu segment 411 includes two PSBu sub-segments: a preamble 412 of the PSBu segment 411 and a delimiter 413 of the PSBu segment 411. The preamble 412 may be composed of a repeated (padded) PRBS sequence or a repetition of a pattern of up to 64 bits. The delimiter 413 is configured to support identification and delineation of the upstream burst 400. The PHY burst payload 420 includes one or more allocations (for purposes of clarity, two allocations are depicted) arranged between a pair of framing-sublayer (FS) elements, starting with an FS header and terminated by an FS trailer. As depicted in FIG. 4, the FS header includes a 10-bit ONU-ID field, a 9-bit Indication (Ind) field, a 13-bit hybrid error correction (HEC) field, and, optionally, a PLOAMu field (0 bytes when not included, 48 bytes when included). As depicted in FIG. 4, each allocation may include an US Dynamic Bandwidth Report (DBRu) header and an FS payload, where the DBRu header includes a 3-byte Buffer Occupancy (BufOcc) field and a 1-byte cyclic redundancy check (CRC) field. As depicted in FIG. 4, the FS trailer includes a 4-byte bit interleaved parity (BIP) field.

In the more recent 50G PON standard and the associated common transmission conversion layer specification, the ability to include up to four PSBu segments in the PSBu was primarily motivated by the fact that the higher speed US transmission rates are expected to require receiver side DSP equalizer training in addition to the typical burst mode receiver subsystem operations such as amplitude recovery (AR) and clock recovery (CR). These various receiver subsystem operations may have different requirements on the training sequences to achieve rapid convergence. Consequently, enabling transmission of distinct preamble/delimiter patterns enables efficient realization of the different subsystem operations (such as AR, CR, and equalizer training). In addition to allowing for repeated long pseudo-random binary sequences (PRBS) with padded zeroes in the preamble, the standard also supports repetitions of a programmable custom pattern of up to 64 bits for the preamble. For the delimiter, the standard supports a 32-bit or 64-bit programmable custom pattern. Nevertheless, the burst detection scheme considered in the standard still relies on the previously presented baseline strategy of matching the final delimiter while tolerating a certain number of bit errors, which may be insufficient in various situations (e.g., where higher speed US transmission rates are employed).

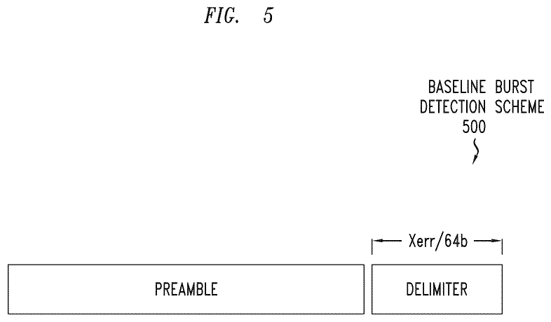

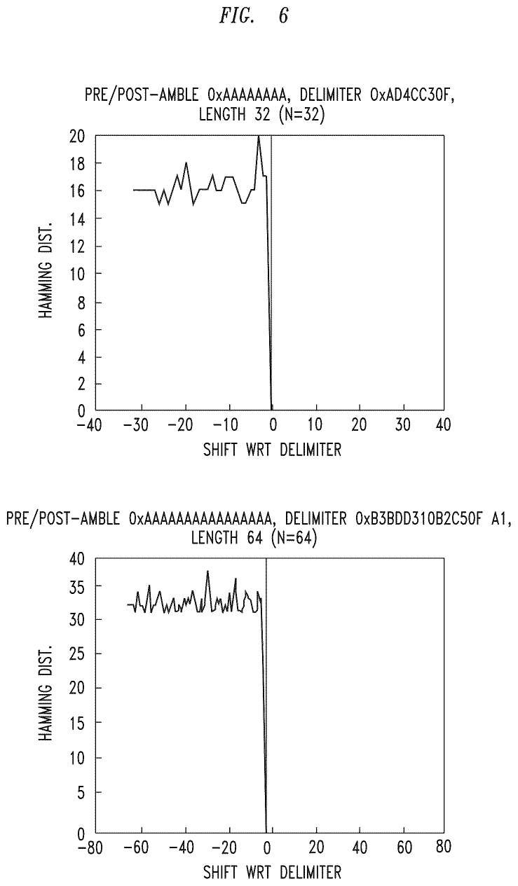

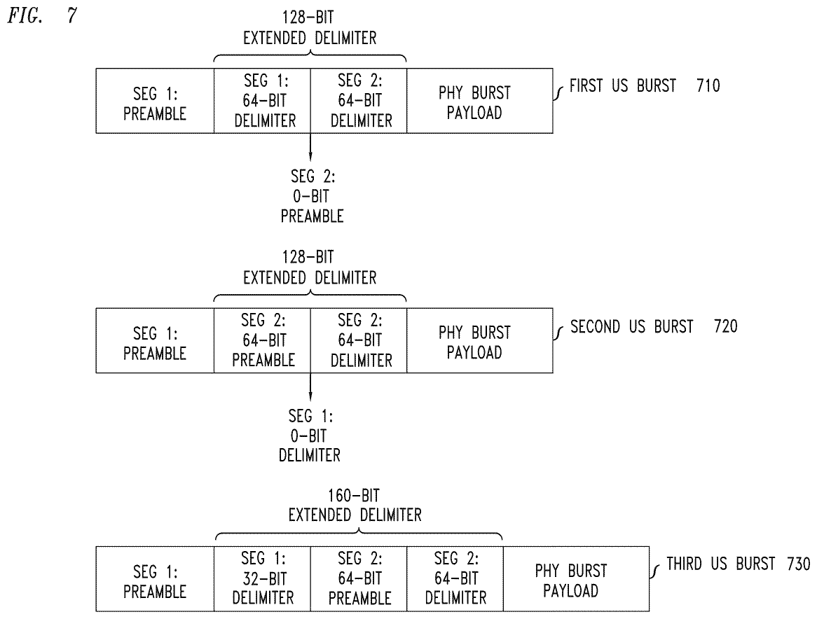

Consider the baseline burst detection scheme that is based on identifying, in the received bit stream, the first occurrence of an N-bit delimiter with up to Y bit errors. The baseline burst detection scheme for a 64-bit delimiter is depicted in FIG. 5 as baseline burst detection scheme 500. The maximum value for the number of tolerable errors, Eₘₐₓ, depends on the minimum Hamming distance of the N-bit delimiter with respect to preceding N-bit blocks containing portions of the preamble and shifted versions of the delimiter. For well-chosen preamble and delimiter combinations, this Hamming distance can be as high as Dₘₐₓ=floor(N/2)−1, which yields a maximum number of tolerated errors of Eₘₐₓ=floor(N/4)−1. The Hamming distance to shifted preceding versions is illustrated in FIG. 6 for certain preamble and delimiter combinations specified in the G.9804 standard (illustratively, for N=32 at the top of FIG. 6 and for N=64 at the bottom of FIG. 6). The value of Eₘₐₓ is then typically used to estimate the highest PSEB for a channel with a specific BER assuming a binary symmetric channel (BSC) model. For example, when Eₘₐₓ=floor(N/4)−1 errors are tolerated,

$$PSEB = ( \begin{matrix}N \\ {E}_{max} + 1\end{matrix} ) {BER}^{{E}_{max} + 1}$$

(see Appendix III of G.9804.3). Along similar lines, assuming values of Y in the baseline burst detection scheme (these are typically chosen such that X≤Eₘₐₓ), the PMB may be estimated. PON standards typically require reliable operation at a target BER, such as 1e-2 in the G.9804.3 standard.

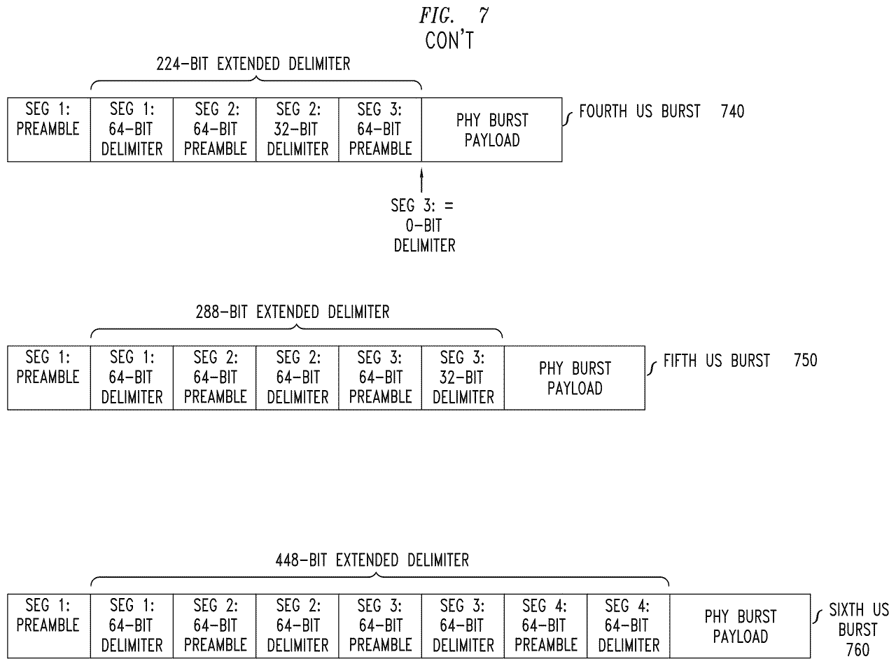

Burst detection may be improved based on use of an extended delimiter according to various embodiments. The extended delimiter may be compatible with the G.9804 standard while also being longer than the 64-bit delimiter defined in the G.9804 standard. The extended delimiter may be defined within the PSBu of a burst based on a combination of PSBu segments allowed by the G.hsp standard, which allows for the OLT to configure ONUs to transmit multiple PSBu segments in an upstream burst. As previously discussed, while only one PSBu segment needs to be included in a PSBu, up to four segments can be configured within a PSBu. For each PSBu segment, the PSBu segment includes a preamble and a delimiter which may be based on the following settings: (1) the preamble can be L 64-bit words long with the following patterns: a PRBSX pattern padded with 0 and with X=8, . . . , 15 or a custom repetitive pattern that is 4, 8, . . . , 64 bits long and (2) the delimiter can be 0, 1, or 2 32-bit words long, with any custom bit pattern. The extended delimiter may be constructed, in multiple ways, from the preamble and/or delimiter portions of two of more PSBu segments in order to provide a delimiter that is greater than the standard 64-bit delimiter, thereby enabling the comparison for the delimiter/burst detection to be applied over a longer bit-sequence and, thus, providing to better burst detection capabilities. It will be appreciated that various example embodiments for constructing extended delimiters from PSBu segments are illustrated in FIG. 7.

FIG. 7 depicts example embodiments for construction of an extended delimiter based on multiple PSBu segments of a PSBu.

As illustrated in FIG. 7, a first US burst 710 includes a PSBu and a PHY burst payload, where the PSBu includes a 128-bit extended delimiter. The PSBu includes a first PSBu segment (denoted as Seg 1) and a second PSBu segment (denoted as Seg 2). The preamble for the first US burst 710 is provided in the preamble sub-segment of the first PSBu segment (denoted as Seg 1: Preamble). The 128-bit extended delimiter for the first US burst 710 is constructed by concatenating a 64-bit delimiter bit pattern in the delimiter sub-segment of the first PSBu segment (denoted as Seg 1:64-bit delimiter), a 0-bit delimiter bit pattern in the preamble sub-segment of the second PSBu segment (denoted as Seg 2:0-bit preamble), and a 64-bit delimiter bit pattern in the delimiter sub-segment of the second PSBu segment (denoted as Seg 2:64-bit delimiter). In this manner, the three sub-segments, or portions, of the first PSBu segment and the second PSBu segment are concatenated such that a combination of the bit patterns of the concatenated PSBu sub-segments forms an extended delimiter that is 128 bits long (a 128-bit bit pattern having a typical delimiter-bit-pattern-characteristic suitable for use as a delimiter for burst detection), thereby supporting improved burst detection for the first US burst 710.

As illustrated in FIG. 7, a second US burst 720 includes a PSBu and a PHY burst payload, where the PSBu includes a 128-bit extended delimiter. The PSBu includes a first PSBu segment (denoted as Seg 1) and a second PSBu segment (denoted as Seg 2). The preamble for the second US burst 720 is provided in the preamble sub-segment of the first PSBu segment (denoted as Seg 1: Preamble). The 128-bit extended delimiter for the second US burst 720 is constructed by concatenating a 0-bit delimiter bit pattern in the delimiter sub-segment of the first PSBu segment (denoted as Seg 1:0-bit delimiter), a 64-bit delimiter bit pattern in the preamble sub-segment of the second PSBu segment (denoted as Seg 2:64-bit preamble), and a 64-bit delimiter bit pattern in the delimiter sub-segment of the second PSBu segment (denoted as Seg 2:64-bit delimiter). In this manner, the three sub-segments, or portions, of the first PSBu segment and the second PSBu segment are concatenated such that a combination of the bit patterns of the concatenated PSBu sub-segments forms an extended delimiter that is 128 bits long (a 128-bit bit pattern having a typical delimiter-bit-pattern-characteristic suitable for use as a delimiter for burst detection), thereby supporting improved burst detection for the second US burst 720.

As illustrated in FIG. 7, a third US burst 730 includes a PSBu and a PHY burst payload, where the PSBu includes a 160-bit extended delimiter. The PSBu includes a first PSBu segment (denoted as Seg 1) and a second PSBu segment (denoted as Seg 2). The preamble for the third US burst 730 is provided in the preamble sub-segment of the first PSBu segment (denoted as Seg 1: Preamble). The 160-bit extended delimiter for the third US burst 730 is constructed by concatenating a 32-bit delimiter bit pattern in the delimiter sub-segment of the first PSBu segment (denoted as Seg 1:32-bit delimiter), a 64-bit delimiter bit pattern in the preamble sub-segment of the second PSBu segment (denoted as Seg 2:64-bit preamble), and a 64-bit delimiter bit pattern in the delimiter sub-segment of the second PSBu segment (denoted as Seg 2:64-bit delimiter). In this manner, the three sub-segments, or portions, of the first PSBu segment and the second PSBu segment are concatenated such that a combination of the bit patterns of the concatenated PSBu sub-segments forms an extended delimiter that is 160 bits long (a 160-bit bit pattern having a typical delimiter-bit-pattern-characteristic suitable for use as a delimiter for burst detection), thereby supporting improved burst detection for the third US burst 730.

As illustrated in FIG. 7, a fourth US burst 740 includes a PSBu and a PHY burst payload, where the PSBu includes a 224-bit extended delimiter. The PSBu includes a first PSBu segment (denoted as Seg 1), a second PSBu segment (denoted as Seg 2), and a third PSBu segment (denoted as Seg 3). The preamble for the fourth US burst 740 is provided in the preamble sub-segment of the first PSBu segment (denoted as Seg 1: Preamble). The 224-bit extended delimiter for the fourth US burst 740 is constructed by concatenating a 64-bit delimiter bit pattern in the delimiter sub-segment of the first PSBu segment (denoted as Seg 1:64-bit delimiter), a 64-bit delimiter bit pattern in the preamble sub-segment of the second PSBu segment (denoted as Seg 2:64-bit preamble), a 32-bit delimiter bit pattern in the delimiter sub-segment of the second PSBu segment (denoted as Seg 2:32-bit delimiter), a 64-bit delimiter bit pattern in the preamble sub-segment of the third PSBu segment (denoted as Seg 3:64-bit preamble), and a 0-bit delimiter bit pattern in the delimiter sub-segment of the third PSBu segment (denoted as Seg 3:0-bit delimiter). In this manner, the five sub-segments, or portions, of the first PSBu segment, the second PSBu segment, and the third PSBu segment are concatenated such that a combination of the bit patterns of the concatenated PSBu sub-segments forms an extended delimiter that is 224 bits long (a 224-bit bit pattern having a typical delimiter-bit-pattern-characteristic suitable for use as a delimiter for burst detection), thereby supporting improved burst detection for the fourth US burst 740.

As illustrated in FIG. 7, a fifth US burst 750 includes a PSBu and a PHY burst payload, where the PSBu includes a 288-bit extended delimiter. The PSBu includes a first PSBu segment (denoted as Seg 1), a second PSBu segment (denoted as Seg 2), and a third PSBu segment (denoted as Seg 3). The preamble for the fifth US burst 750 is provided in the preamble sub-segment of the first PSBu segment (denoted as Seg 1: Preamble). The 288-bit extended delimiter for the fifth US burst 750 is constructed by concatenating a 64-bit delimiter bit pattern in the delimiter sub-segment of the first PSBu segment (denoted as Seg 1:64-bit delimiter), a 64-bit delimiter bit pattern in the preamble sub-segment of the second PSBu segment (denoted as Seg 2:64-bit preamble), a 64-bit delimiter bit pattern in the delimiter sub-segment of the second PSBu segment (denoted as Seg 2:64-bit delimiter), a 64-bit delimiter bit pattern in the preamble sub-segment of the third PSBu segment (denoted as Seg 3:64-bit preamble), and a 32-bit delimiter bit pattern in the delimiter sub-segment of the third PSBu segment (denoted as Seg 3:32-bit delimiter). In this manner, the five sub-segments, or portions, of the first PSBu segment, the second PSBu segment, and the third PSBu segment are concatenated such that a combination of the bit patterns of the concatenated PSBu sub-segments forms an extended delimiter that is 288 bits long (a 288-bit bit pattern having a typical delimiter-bit-pattern-characteristic suitable for use as a delimiter for burst detection), thereby supporting improved burst detection for the fifth US burst 1150.

As illustrated in FIG. 7, a sixth US burst 760 includes a PSBu and a PHY burst payload, where the PSBu includes a 448-bit extended delimiter. The PSBu includes a first PSBu segment (denoted as Seg 1), a second PSBu segment (denoted as Seg 2), a third PSBu segment (denoted as Seg 3), and a fourth PSBu segment (denoted as Seg 4). The preamble for the sixth US burst 760 is provided in the preamble sub-segment of the first PSBu segment (denoted as Seg 1: Preamble). The 448-bit extended delimiter for the sixth US burst 760 is constructed by concatenating a 64-bit delimiter bit pattern in the delimiter sub-segment of the first PSBu segment (denoted as Seg 1:64-bit delimiter), a 64-bit delimiter bit pattern in the preamble sub-segment of the second PSBu segment (denoted as Seg 2:64-bit preamble), a 64-bit delimiter bit pattern in the delimiter sub-segment of the second PSBu segment (denoted as Seg 2:64-bit delimiter), a 64-bit delimiter bit pattern in the preamble sub-segment of the third PSBu segment (denoted as Seg 3:64-bit preamble), a 64-bit delimiter bit pattern in the delimiter sub-segment of the third PSBu segment (denoted as Seg 3:64-bit delimiter), a 64-bit delimiter bit pattern in the preamble sub-segment of the fourth PSBu segment (denoted as Seg 4:64-bit preamble), and a 64-bit delimiter bit pattern in the delimiter sub-segment of the fourth PSBu segment (denoted as Seg 4:64-bit delimiter). In this manner, the seven sub-segments, or portions, of the first PSBu segment, the second PSBu segment, the third PSBu segment, and the fourth PSBu segment are concatenated such that a combination of the bit patterns of the concatenated PSBu sub-segments forms an extended delimiter that is 448 bits long (a 448-bit bit pattern having a typical delimiter-bit-pattern-characteristic suitable for use as a delimiter for burst detection), thereby supporting improved burst detection for the sixth US burst 760.

It will be appreciated that, although primarily presented with respect to generation of specific extended delimiters having specific lengths, based on use of specific numbers of PSBu segments having specific preamble sub-segment and delimiter sub-segment sizes, various other extended delimiters having various other lengths may be defined based on various combinations of PSBu segments having preamble sub-segments and delimiter sub-segments sized in accordance with rules for the preamble sub-segments and delimiter sub-segments of PSBu segments of the PSBu.

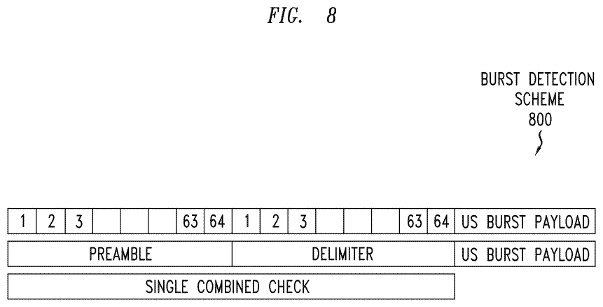

As indicated above, burst detection for an US burst is improved based on construction of an extended delimiter by combining multiple separate delimiter and preamble sub-segments of multiple PSBu segments within the PSBu. The enhanced burst detection capability that is possible with longer delimiters can be understood by recognizing that, since the Hamming distance to shifts can be as high as Dₘₐₓ=floor(N/2)−1, increasing the delimiter length and, thus, increasing the Hamming distance, can allow for use of an increased error threshold (up to Eₘₐₓ=floor(N/4)−1 errors). The benefits of the longer delimiter in supporting burst detection may be further understood by considering a burst detection scheme based on use of an extended delimiter, an example of which is presented in FIG. 8 (for the second US burst 720 of FIG. 7, in which a 128-bit extended delimiter is used based on concatenation of a delimiter bit pattern in a 64-bit preamble sub-segment and a delimiter bit pattern in a 64-bit delimiter sub-segment in the second PSBu segment of the PSBu) for comparison with the baseline burst detection scheme presented with respect to FIG. 5.

As indicated above, burst detection for an US burst is improved based on construction of a 128-bit extended delimiter based on concatenation of a delimiter bit pattern in a 64-bit preamble sub-segment and a delimiter bit pattern in a 64-bit delimiter sub-segment in the second PSBu segment of the PSBu. More specifically, an L*64-bit enhanced delimiter with L=2, to provide the desired 128-bit enhanced delimiter, may be realized by programming the 64-bit preamble sub-segment and the 64-bit delimiter sub-segment for the final PSBu segment (i.e., the PSBu segment just before the payload). With this 128-bit pattern, delimiter detection can be performed by error checking over 128 bits with a single error threshold Z as illustrated with respect to the burst detection scheme 800 of FIG. 8. As compared to the baseline burst detection scheme presented in FIG. 5, the enhanced burst detection involves flagging a burst as detected as long as the number of errors detected in the combined 128-bit word is less than or equal to Z, which may be taken twice as large as Y.

It will be appreciated that, although primarily presented herein with respect to use of the extended delimiters for upstream bursts from ONUs to the OLT, in at least some example embodiments the extended delimiter may be used for downstream bursts from the OLT to the ONUs for systems that use burst mode operation in downstream. In at least some example embodiments, the extended delimiter may be defined based on use of a structure similar to the PSBu, but defined for downstream. In at least some example embodiments, the OLT may send instructions to the ONUs to define the formats of the extended delimiters that the ONUs should expect for downstream bursts from the OLT to the ONUs, the OLT may generate the extended delimiters for the ONUs based on the formats for the extended delimiters and send the downstream bursts to the ONUs using the extended delimiters, and the ONUs may receive the downstream bursts from the OLT and detect the downstream bursts from the OLT using the extended delimiters, respectively. In at least some example embodiments, the ONUs may send instructions to the OLT to define the formats of the extended delimiters expected by the ONUs for downstream bursts from the OLT to the ONUs, the OLT may generate the extended delimiters for the ONUs based on the instructions from the ONUs and send the downstream bursts to the ONUs using the extended delimiters, and the ONUs may receive the downstream bursts from the OLT and detect the downstream bursts from the OLT using the extended delimiters, respectively. It will be appreciated that various example embodiments presented herein for supporting use of extended delimiters for US bursts may be adapted for supporting use of extended delimiters for DS bursts.

It will be appreciated that, since the extended delimiters may be used in the upstream direction (i.e., ONU to OLT) for US bursts and may be used in the downstream direction (i.e., OLT to ONU) for DS bursts, upstream-specific terms and downstream-specific terms used herein may be referred to more generally using terms that do not specify a direction of transmission (e.g., the PSBu for US bursts and a similar term that may be defined for the PSB for DS bursts may be referred to more generally as a physical synchronization block (PSB), the PSBu segment for US bursts and the a similar term which may be defined for the PSB segments of DS bursts may be referred to more generally as PSB segments, the PSBu sub-segments for US bursts and a similar term which may be defined for the PSB sub-segments of DS bursts may be referred to more generally as PSB sub-segments, and so forth).

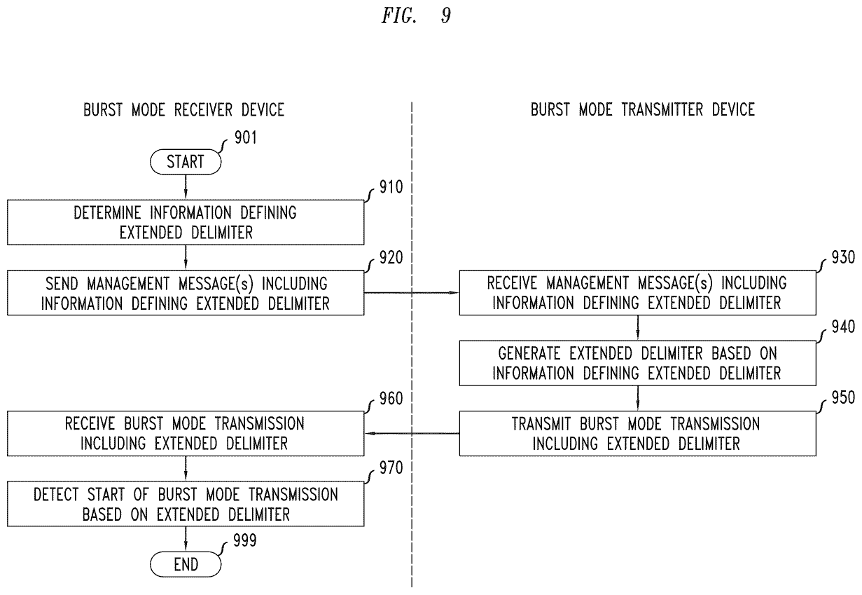

FIG. 9 depicts an example embodiment of a method for use by an optical communication system to support burst mode communications based on an extended delimiter. In the method 900, a portion of the functions are performed by the burst mode receiver device (e.g., an OLT in a PON) and a portion of the functions are performed by the burst mode transmitter device (e.g., an ONU in a PON) where, here, the references to “receiver” and “transmitter” are within the context of the burst mode communications performed using the extended delimiter. It will be appreciated that, although primarily presented as being performed serially, at least a portion of the functions of the method 900 may be performed contemporaneously or in a different order than as presented with respect to FIG. 9. At block 901, the method 900 begins. At block 910, the burst mode receiver device determines information defining an extended delimiter for use by the burst mode transmitter device for burst mode transmissions toward the burst mode receiver device. At block 920, the burst mode receiver device sends, toward the burst mode transmitter device, one or more management messages including the information defining the extended delimiter. At block 930, the burst mode transmitter device receives, from the burst mode receiver device, the one or more management messages including the information defining the extended delimiter. At block 940, the burst mode transmitter device generates an extended delimiter, for use in a burst transmission, based on the information defining the extended delimiter. At block 950, the burst mode transmitter device transmits a burst mode transmission including the extended delimiter. At block 960, the burst mode receiver devices receives the burst mode transmission including the extended delimiter. At block 970, the burst mode receiver device detects a start of the burst mode transmission based on the extended delimiter. At block 999, the method 900 ends.

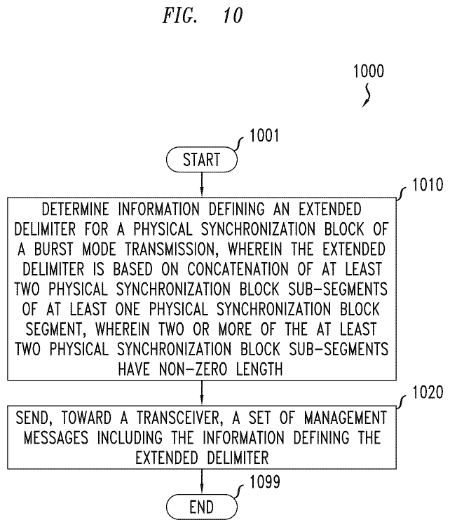

FIG. 10 depicts an example embodiment of a method for use by a burst mode receiver to supporting burst mode communications based on an extended delimiter. It will be appreciated that, although primarily presented as being performed serially, at least a portion of the functions of the method 1000 may be performed contemporaneously or in a different order than as presented with respect to FIG. 10. At block 1001, the method 1000 begins. At block 1010, determine information defining an extended delimiter for a physical synchronization block of a burst mode transmission, wherein the extended delimiter is based on concatenation of at least two physical synchronization block sub-segments of at least one physical synchronization block segment, wherein two or more of the at least two physical synchronization block sub-segments have non-zero length. At block 1020, send, toward a transceiver, a set of management messages including the information defining the extended delimiter. At block 1099, the method 1000 ends.

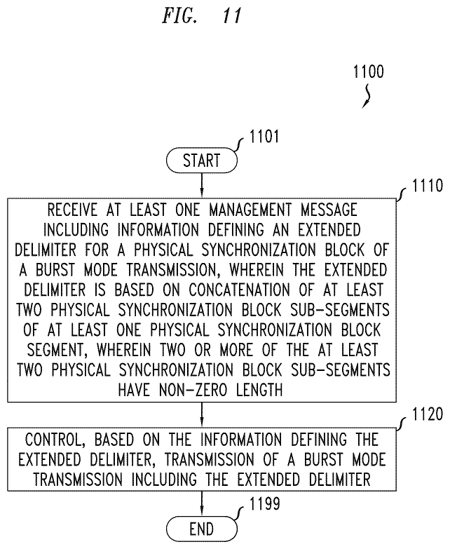

FIG. 11 depicts an example embodiment of a method for use by a burst mode transmitter for supporting burst mode communications based on an extended delimiter. It will be appreciated that, although primarily presented as being performed serially, at least a portion of the functions of the method 1100 may be performed contemporaneously or in a different order than as presented with respect to FIG. 11. At block 1101, the method 1100 begins. At block 1110, receive at least one management message including information defining an extended delimiter for a physical synchronization block of a burst mode transmission, wherein the extended delimiter is based on concatenation of at least two physical synchronization block sub-segments of at least one physical synchronization block segment, wherein two or more of the at least two physical synchronization block sub-segments have non-zero length. At block 1120, control, based on the information defining the extended delimiter, transmission of a burst mode transmission including the extended delimiter. At block 1199, the method 1100 ends.

Various example embodiments for supporting burst mode communications based on use of extended delimiters may provide various advantages or potential advantages. For example, various example embodiments for supporting burst mode communications based on use of extended delimiters may be configured to provide improved burst mode communications. For example, various example embodiments for supporting burst mode communications based on use of extended delimiters may be configured to provide improved burst mode communications by supporting improved burst detection based on improved delineation of burst payloads. For example, various example embodiments for supporting burst mode communications based on use of extended delimiters may be configured to provide improved burst mode communications in various PON systems employing BM operation, including TDM PON, TWDM PONs, or the like. For example, various example embodiments for supporting burst mode communications based on use of extended delimiters may be configured to support minimization of both PMB and PSEB for the worst-case upstream channels in PON systems. It will be appreciated that various example embodiments for supporting burst mode communications based on use of extended delimiters may be configured to provide various other advantages or potential advantages.

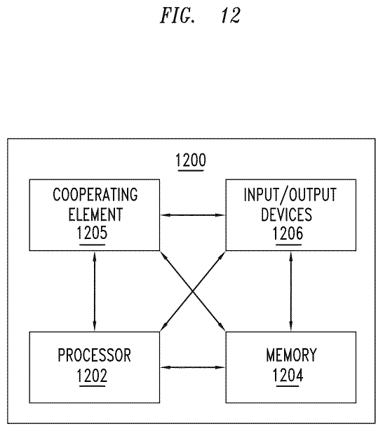

FIG. 12 depicts an example embodiment of a computer suitable for use in performing various functions presented herein.

The computer 1200 includes a processor 1202 and a memory 1204. The processor 1202 may be a processing unit (e.g., a central processing unit (CPU), a graphics processing unit (GPU), or the like) having one or more cores, a core of a processing unit, or the like. The memory 1204 may be a random access memory (RAM), a read-only memory (ROM), or the like. In at least some example embodiments, the computer 1200 may include at least one processor (e.g., processor 1202) and at least one memory (e.g., memory 1204) storing instructions that, when executed by the at least one processor, cause the computer 1200 to perform various functions presented herein.

The computer 1200 also may include a cooperating element 1205. The cooperating element 1205 may be hardware, firmware, software, or various combinations thereof. The cooperating element 1205 may be a process that can be loaded into the memory 1204 and executed by the processor 1202 to implement various functions presented herein (in which case, for example, the cooperating element 1205 (including associated data structures) can be stored on a non-transitory computer readable medium, such as a storage device or other suitable type of storage element (e.g., a magnetic drive, an optical drive, or the like)).

The computer 1200 also may include one or more input/output devices 1206. The input/output devices 1206 may include one or more of a user input device (e.g., a keyboard, a keypad, a mouse, a microphone, a camera, or the like), a user output device (e.g., a display, a speaker, or the like), one or more network communication devices or network communication elements (e.g., an input port, an output port, a receiver, a transmitter, a transceiver, or the like), one or more storage devices (e.g., a tape drive, a floppy drive, a hard disk drive, a solid state drive, or the like), or the like, as well as various combinations thereof.

It will be appreciated that computer 1200 may represent a general architecture and functionality suitable for implementing functional elements described herein, portions of functional elements described herein, or the like, as well as various combinations thereof. For example, the computer 1200 may provide a general architecture and functionality that is suitable for implementing one or more elements presented herein. For example, the computer 1200 may provide a general architecture and functionality that is suitable for implementing at least one of an OLT or a portion thereof, an ONU or a portion thereof, an optical transmitter or a portion thereof, an optical receiver or a portion thereof, an optical transceiver or a portion thereof, an optical communication device or a portion thereof, or the like, as well as various combinations thereof.

It will be appreciated that at least some of the functions presented herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits, and/or any other hardware equivalents).

It will be appreciated that at least some of the functions presented herein may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer readable media), transmitted via a data stream in a broadcast or other signal bearing medium, and/or stored within a memory within a computing device operating according to the instructions.

It will be appreciated that the term “non-transitory” as used herein is a limitation of the medium itself (i.e., tangible, not a signal) as opposed to a limitation of data storage persistency (e.g., RAM versus ROM).

It will be appreciated that, as used herein, “at least one of <a list of two or more elements>” and “at least one of the following: <a list of two or more elements>” and similar wording, where the list of two or more elements are joined by “and” or “or”, mean at least any one of the elements, or at least any two or more of the elements, or at least all the elements.

It will be appreciated that, as used herein, the term “or” refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

1-20. (canceled)

21. An apparatus, comprising:
at least one processor; and
at least one memory storing instructions which, when executed by the at least one processor, cause the apparatus at least to:
determine information defining an extended delimiter for a physical synchronization block of a burst mode transmission, wherein the extended delimiter is based on concatenation of at least two physical synchronization block sub-segments of at least one physical synchronization block segment, wherein two or more of the at least two physical synchronization block sub-segments have non-zero length; and
send, toward a transceiver, a set of management messages including the information defining the extended delimiter.

22. The apparatus of claim 21, wherein the information defining the extended delimiter comprises, for each of the two or more of the at least two physical synchronization block sub-segments, a respective indication of a length of the physical synchronization block sub-segment and a respective indication of a bit pattern for the physical synchronization block sub-segment.

23. The apparatus of claim 21, wherein the apparatus is configured to be disposed within a passive optical network, wherein the set of management messages comprises at least one physical layer operations administration and maintenance (PLOAM) message.

24. The apparatus of claim 21, wherein the apparatus is configured to be disposed within a passive optical network, wherein the set of management message comprises, for each of the at least two physical synchronization block sub-segments, a respective physical layer operations administration and maintenance (PLOAM) message for the respective physical synchronization block segment.

25. The apparatus of claim 21, wherein the two or more of the at least two physical synchronization block sub-segments belong to a same one of the at least one physical synchronization block segment.

26. The apparatus of claim 21, wherein the two or more of the at least two physical synchronization block sub-segments belong to different ones of the at least one physical synchronization block segment.

27. The apparatus of claim 21, wherein the at least one physical synchronization block segment includes a first physical synchronization block segment and a second physical synchronization block segment, wherein the two or more of the at least two physical synchronization block sub-segments include a first physical synchronization block sub-segment belonging to the first physical synchronization block segment and a second physical synchronization block sub-segment belonging to the second physical synchronization block segment.

28. The apparatus of claim 21, wherein the two or more of the at least two physical synchronization block sub-segments include at least two delimiter sub-segments.

29. The apparatus of claim 21, wherein the two or more of the at least two physical synchronization block sub-segments include at least one preamble sub-segment and at least one delimiter sub-segment.

30. The apparatus of claim 21, wherein the two or more of the at least two physical synchronization block sub-segments include at least two preamble sub-segments.

31. The apparatus of claim 21, wherein, for each of the two or more of the at least two physical synchronization block sub-segments, the respective physical synchronization block sub-segment is defined to include a respective bit pattern characteristic of a delimiter bit pattern and configured for use as a respective portion of the extended delimiter.

32. The apparatus of claim 21, wherein the extended delimiter comprises a 96-bit delimiter based on concatenation of a 32-bit physical synchronization block sub-segment and a 64-bit physical synchronization block sub-segment.

33. The apparatus of claim 21, wherein the extended delimiter comprises a 128-bit delimiter based on concatenation of a first 64-bit physical synchronization block sub-segment and a second 64-bit physical synchronization block sub-segment.

34. The apparatus of claim 21, wherein the extended delimiter comprises an M×N bit delimiter, wherein M comprises a number of sub-segments in the two or more of the at least two sub-segments and N comprises a number of bits per sub-segment in the two or more of the at least two sub-segments.

35. The apparatus of claim 21, wherein the instructions, when executed by the at least one processor, cause the apparatus at least to:
receive a bit stream of a burst mode transmission, wherein the burst mode transmission includes a burst payload and the extended delimiter; and
recover, based on identification of the burst mode transmission using the extended delimiter, the burst payload.

36. The apparatus of claim 35, wherein, for each of the two or more of the at least two physical synchronization block sub-segments, the respective physical synchronization block sub-segment includes a respective bit pattern for use as a respective portion of the extended delimiter.

37. The apparatus of claim 21, wherein the information defining the extended delimiter is configured for use by the transceiver when transmitting the burst mode transmission.

38. The apparatus of claim 21, wherein the apparatus comprises an optical line terminal or an optical network unit.

39. A method, comprising:
determining information defining an extended delimiter for a physical synchronization block of a burst mode transmission, wherein the extended delimiter is based on concatenation of at least two physical synchronization block sub-segments of at least one physical synchronization block segment, wherein two or more of the at least two physical synchronization block sub-segments have non-zero length; and
sending, toward a transceiver, a set of management messages including the information defining the extended delimiter

40. An apparatus, comprising:
at least one processor; and
at least one memory storing instructions which, when executed by the at least one processor, cause the apparatus at least to:
receive at least one management message including information defining an extended delimiter for a physical synchronization block of a burst mode transmission, wherein the extended delimiter is based on concatenation of at least two physical synchronization block sub-segments of at least one physical synchronization block segment, wherein two or more of the at least two physical synchronization block sub-segments have non-zero length; and
control, based on the information defining the extended delimiter, transmission of a burst mode transmission including the extended delimiter.
